(19) United States
(12) Patent Application Publication
(10) Pub. No.: US 2020/0362203 A1
(43) Pub. Date: Nov. 19, 2020

(54) METHOD AND DEVICE FOR PRODUCING A HAND-TEARABLE TEXTILE ADHESIVE TAPE

(71) Applicant: Certoplast Vorwek & Sohn GmbH, Wuppertal (DE)

(72) Inventor: Peter RAMBUSCH, Wuppertal (DE)

(21) Appl. No.: 14/370,235

(22) PCT Filed: Jan. 3, 2013
(86) PCT No.: PCT/EP2013/050065

§ 371 Date: Mar. 21, 2019

(30) Foreign Application Priority Data
Jan. 4, 2012 (DE) 10 2012 100 055.7

(51) Int. Cl. C09J 7/21

(52) U.S. Cl. CPC C09J 7/21; C09J 2467/006; C09J 2400/263; C09J 2203/302

(57) ABSTRACT

The invention relates to a method and a device for producing a hand-tearable textile adhesive tape. First of all, a textile carrier tape (T) is treated, using a processing liquid (4) which acts upon the fibres, for long enough for its tear-resistance to fall below 100 N/cm. The textile carrier tape (T) is then washed and neutralised, and lastly a coating comprising an adhesive is applied to at least one side of said textile carrier tape (T).

The invention relates to a method of making a hand-tearable textile adhesive tape.

Hand-tearable textile adhesive tapes are typically used to wrap cable looms in automobiles. Hand tearability in this context ensures that an assembly worker is able to unwind such an adhesive tape from its roll and tear it by hand, usually transversely, without difficulty to the desired length without additional tools such as scissors or a knife. So as to ensure the required hand tearability, different lines of development are pursued in the related art.

In fact, EP 2 050 802 of applicant describes a mixed woven fabric with a warp of polyester fibers or filaments and a cotton weft. This adhesive tape can thus be torn particularly easily transversely, that is weftwise.

In the known teaching according to DE 10 2005 044 942, from which the invention proceeds, the textile support tape is treated with lye when of polyester or with acid when of polyamide so as to thus ensure the desired reduced fiber tear strength of the backing material. However, the above-described prior publications only provide general teachings, and details of the process and of the reduction in the fiber tear strength that is achieved, or that is achievable, in general remain open.

DE 31 43 064 that is likewise relevant at this point, relates to a velour that can be coated and previously subjected to alkalinization. This document also addresses various parameters of the lye treatment, however it remains open whether, at the end of this treatment, the desired hand tearability in fact exists or was able to be achieved.

U.S. Pat. No. 6,790,505 relates to a polyester woven textile support tape as a basis for an adhesive tape. In this connection, tearing forces of less than 10 N are observed by a special selection of the parameters of the woven fabric. However, this requires a special weaving process.

DE 102 59 616 relates to an adhesive tape in which the support tape is composed of a heat-bonded nonwoven fabric. As a result of the adhesive that is used, the support tape material is bonded so that it is easily tearable by hand transversely to its longitudinal extension such that tensile strength values of 15 to 30 N/cm are observed.

DE 747 117 generally concerns the textile finishing of polyamide fibers. Here, Example 9 describes the treatment of polyamide fibers with formic acid at a temperature of 20 to 25° C. After a treatment time of 3 minutes, the polyamide fibers are washed and dried. In this way, strength can be reduced by approximately 2% to approximately 40%.

The prior art has previously only provided approaches insofar as, for example, to how the tensile strength of a polyester woven textile support tape as the starting material for making an adhesive tape can be reduced in general. However, detailed information is still absent insofar as to how the relevant parameters are to be set and what tensile strength values are acceptable to begin with, or how much the tensile strength has to be reduced so as to achieve the desired hand tearability. This is where the invention comes in.

The object of the invention is to refine a method of the type described above in such a way that the desired hand tearability is always achieved, while adhering to reproducible criteria.

To attain this object, a method of the type in question for making a hand-tearable textile adhesive tape within the scope of the invention includes the following method steps:
treating a textile support tape with a processing liquid capable of weakening fibers until a tensile strength of the tape is less than approximately 100 N/cm;
subsequently washing and neutralizing the textile support tape; and
finally applying a coating containing an adhesive to at least one side of the support tape.

Within the scope of the invention, first a textile adhesive tape is made from a textile support tape itself made of a flexible fiber composite. This means that, within the scope of the invention, the term “textile support tape” essentially includes woven or knitted fabrics. According to an advantageous embodiment, however, the textile support tape is generally a woven textile support tape.

According to DE 20 2007 006 816, tensile strength of less than 100 N/cm is qualified in the related art already as “hand-tearable.” However, so as to adjust this tensile strength, the known and above-described teaching employs a special woven fabric support in which the titer of the longitudinal filaments is at least 2600 dtex/cm and the titer of transverse filaments based on length is at least 4700 dtex/cm. Moreover, the filament density of the transverse filaments is at least 28 filaments per cm length.

In contrast, the teaching according to the invention dispenses with such specifications. Rather, the only aspect that is essential is that of treating the textile support tape, and in particular the woven textile support tape, with processing liquid acting on the fibers in a targeted manner, and more particularly until the woven textile support tape has a tensile strength of less than 100 N/cm, and consequently is essentially tearable by hand. This also applies when a support tape thus treated is subsequently provided on one or both sides with the adhesive coating. The reason for this is that the adhesive coating barely influences tensile strength, normally by less than 10%.

The described tensile strength of less than 100 N/cm is typically observed within the scope of the invention in the longitudinal warp direction of the woven textile support tape. As a result, the woven textile support tape in question, and of course also the textile adhesive tape according to the invention produced therefrom, is easy to tear transversely to the warp direction, that is weftwise. This is the usual procedure.

According to an advantageous embodiment, the above-described treatment process using the processing liquid is moreover carried out and controlled in such a way that the tensile strength of the treated textile support tape is reduced by at least approximately 5%, and usually by approximately 10% or more, as compared to the starting condition. In general, a special woven textile support tape is used at this point within the scope of the invention, this being a polyester woven textile support tape.

Such polyester woven textile support tapes have particular advantages during the subsequent use of the adhesive tape according to the invention for wrapping cable harnesses in automobiles. Polyester woven textile support tapes, for example, have high abrasion resistance and good electrical insulation properties, combined with significant dimensional stability. Due to the treatment with the processing liquid acting on the fibers that takes place within the scope of the invention, the hand tearability characteristic, which in starting condition is poor or at times even nonexistent, is created since the tensile strength is adjusted to values of less than 100 N/cm (longitudinally of the adhesive tape). Polyester woven textile support tapes in fact typically have tensile strength values of considerably more than 100 N/cm to start with. These are the most important advantages.

According to an advantageous embodiment, the textile support tape can be treated with the processing liquid in a continuous or a discontinuous process. The textile support tape is usually guided continuously through a treatment bath, or through a treatment device in general, at a predefined speed and in at least one pass. For this purpose, speeds of approximately 20 m/min, and more particularly 30 m/min and more, have been found to be favorable. Preferably, a speed of 40 m/min can even be employed.

Moreover, the design in this context is generally such that the textile support tape is treated with the processing liquid for a treatment time of at least 4 minutes. Essentially, a longer treatment time can also be employed. In addition, the treatment can be carried out in the treatment bath using a liquor ratio of approximately 1:20 or more. This means that the textile support tape is treated in the treatment bath using the above-described liquor ratio of approximately 1:20 and more.

The liquor ratio, as is customary, expresses the ratio of the quantity of textile support tape to the quantity of processing liquid in the treatment bath. In the case of the continuous treatment of the textile support tape, use of a roller vat can be made that can be provided in the treatment bath. Such roller vats are known per se and are characterized in that in them the textile support tape is guided in a meander over at least two rows of deflection rollers that are set close to each other and at a spacing one above the other. In this way, not only a relatively long residence time or treatment time of the textile support tape in the treatment bath is achieved, but also small housing dimensions. It is thus usually sufficient to guide the support tape only once, that is in one pass, through the treatment bath, although multiple treatments are also possible, of course.

After the textile support tape has been treated in the treatment bath, the textile support tape generally passes through a steam box comprising saturated steam. This is a treatment chamber to which saturated water vapor is applied, so that, depending on the size of this treatment chamber and consequently the residence time of the textile support tape in the treatment chamber, the application time of the processing liquid on the textile support tape can be varied in a continuous process.

As an alternative to the continuous process primarily described above, however, it is also possible to treat the textile support tape with the processing liquid in a discontinuous batch process. Here, the textile support tape is usually wetted with a controllable quantity of the processing liquid as part of a dipping method. The moist support tape can then be rolled and, for example, be constantly turned at a holding station, taking the above-mentioned treatment time into consideration. This ensures that the processing liquid homogeneously treats the textile support tape and does not collect on one side of the support tape, for example, due to gravity. However, within the scope of the invention, the continuous process is typically employed since it is associated with cost advantages during production.

The processing liquid used for the textile support tape is advantageously a lye or an acid. This depends on the material of the textile support tape. If the textile support tape is a polyester woven textile support tape, it is generally alkalinized, and more particularly using sodium hydroxide. In contrast, if the support tape or woven textile support tape is one based on polyamide, an acid, and more particularly formic acid, is employed.

Since polyester woven textile support tapes generally have cost advantages over polyamide woven textile support tapes, primarily the treatment of such polyester woven textile support tapes with sodium hydroxide as part of the alkalinization is described hereafter. Alkalinization here, as is customary, refers to the process of increasing the pH value so that the environment as a whole becomes more alkaline that is generally achieved through the use of sodium hydroxide. Sodium hydroxide having a concentration of at least 10 g/l is typically used for this purpose. Essentially, higher concentrations from 20 g/l to approximately 40 g/l can also be employed. This means that the concentration of sodium hydroxide, which is used particularly advantageously according to the invention, typically ranges between 10 g/l and approximately 40 g/l.

The invention also relates to a system for making a hand-tearable textile adhesive tape, as described in more detail in claim 13 and the following dependent claims 14 and 15. This system operates continuously in the present invention.

The result is a method and a related system for making a hand-tearable textile adhesive tape. The invention for the first time provides reproducible parameters enabling the tensile strength of polyester woven textile support tapes, for example, to be reduced by at least approximately 5%. As a result, tensile strength values of typically less than 100 N/cm are observed that overall make the adhesive tape thus produced more tearable by hand.

The invention will be described in more detail below based on one drawing showing only a single illustrated embodiment. The only FIGURE shows a system for making a hand-tearable textile adhesive tape.

The FIGURE shows a system for making an adhesive tape. For this purpose, the system first of all has a supply 1 holding a roll of a textile support tape T to be fed to the treatment system described below. The textile support tape T in the supply 1 may be a textile web that can be cut into individual adhesive tape strips having a predefined length at the end of the production process to be described.

Downstream in a travel direction A from the supply 1 of the textile support tape T is a treatment device 3 in which the textile support tape T from the supply 1 is treated with a processing liquid 4. It is apparent that the processing liquid 4 has a liquid level shown with dashed lines in the treatment device 3 or the treatment bath therein, and the support tape T is guided in a meander in the processing liquid 4 or through its surface. The treatment device 3 is equipped with roller vats for this purpose that guide the textile support tape T in a meander over deflection rollers multiple times through the processing liquid 4.

The textile support tape T is treated in the treatment device 3 with the processing liquid 4 until the tear strength or tensile strength thereof is less than 100 N/cm. The processing liquid 4 in fact acts on the fibers of the textile support tape T.

In the illustrated embodiment, the textile support tape T is a polyester woven textile support tape that is alkalinized using sodium hydroxide as the processing liquid. The sodium hydroxide is present in a concentration of at least 10 g/l and typically has a temperature of at least approximately 50° C. and more. The maximum concentration of sodium hydroxide is 40 g/l, and the maximum temperature is approximately 80° C. In addition, the textile support tape T is treated in the treatment device 3 for at least 4 minutes.

This means that the treatment time of the textile support tape T within the treatment device 3 is set to at least 4 minutes or more. This treatment time is derived from on the speed with which the textile support tape T is guided through the system shown in the FIGURE in the travel direction A. This speed is approximately 10 m/min and can be increased to approximately 40 m/min.

In this way, the treatment time of 4 minutes or more can be specified and set as a function of the physical dimension or length of the treatment device 3. Overall, tensile strength values of less than 100 N/cm are achieved in this connection at the end of the treatment device 3, and a reduction of the tensile strength of at least 5% compared to the starting condition is achieved when a speed of approximately 40 m/min in the travel direction A is employed and the temperature of the processing liquid 4 or of sodium hydroxide having a concentration of 40 g/l is more than 50° C., and preferably approximately 80° C. The residence time in this case is approximately 4 minutes.

As a result, for example, the tensile strength of the textile support tape T of approximately 105 N/cm in the starting condition, or in the state in the supply 1, is reduced to values of approximately 100 N/cm or 95 N/cm and less at the end of the treatment device 3. This explains a percentage decrease in tensile strength of at least 5%, and of 10% and more in this example.

The described reduction in tensile strength can basically be attributed to the known fact that, during the described alkalinization process within the treatment device 3, the overall diameters of the individual fibers are reduced by the processing liquid 4 acting on the fibers. The reason for this is that alkalinization results in peeling of the surface of the textile support tape T that, from a chemical point of view, represents a degradation of the polyester chains due to a base-catalyzed saponification process. As a result, structural changes of the textile support tape T are observed, with a simultaneous loss of mass of the individual fibers.

Upstream of the treatment device 3 in the travel direction A is a cleaning station 2. This is used in particular to remove any oils or grease from the textile support tape T that may still adhere from the upstream weaving process. As was already described, the treatment device 3 as a whole and in the illustrated embodiment is designed as an alkalinization unit 3. However, the cleaning station 2 can essentially also operate similarly to the treatment device or alkalinization unit 3. In this case, the treatment device 3 and the cleaning station 2 must be considered as one unit 2, 3 that as a whole ensures the above-described properties of the textile support tape T at the output of this unit 2, 3, or at the output of the treatment device 3. This, of course, is not mandatory.

A steamer or a steaming device 5 follows the treatment device 3 in the travel direction A. The steamer 5 is configured with a treatment chamber filled with saturated steam here of water. Respective seals 6 are provided at the input port and are the output port of this treatment chamber of the steamer 5, the seals being designed as liquid seals in the illustrated embodiment.

As described above, the steamer 5 ensures that the overall treatment time of the textile support tape T can be varied. The longer the textile support tape T remains in the treatment chamber of the steamer 5, the shorter is ultimately the treatment time, since the saturated water vapor with which the textile support tape T is treated in the steamer basically ensures that the action of the processing liquid, or of the sodium hydroxide 4, on the textile support tape T is reduced or attenuated. Consequently, the processing time using the processing liquid 4 ultimately refers only to the time when the textile support tape T is in the treatment device 3.

After passing through the steamer 5, the textile support tape T reaches a washer 7 that has individual washing chambers 7′. The textile support tape T is again guided in a meander through the individual washing chambers 7′, so that not only is the processing liquid 4 rinsed off the textile support tape T in the washer 7, but the support tape T also undergoes neutralization. The reason for this is that the conditions are set, at least in the output-side washing chamber 7′, in such a way that a pH of approximately 7 is present there so that overall pH conditions are neutral. At the input and at the output, the washer 7 also has sprayers 8 that direct water directly onto the textile support tape T at the input and at the output.

After treatment with the processing liquid 4, the washer 7 for washing and neutralizing the textile support tape T is followed by a downstream dryer 9. Here, cylinder drying may be employed. In fact, the dryer 9 has multiple heated cylinders that can have a temperature of approximately 100° C. to 130° C., for example. After leaving the washer 7, the textile support tape T is guided in a meander over these individual cylinders of the dryer 9 and are dried. Finally, the dried support tape T is rolled up in a winder 10.

Downstream of this winder 10, the textile support tape T can then be coated in a further step on at least one side with an adhesive. For this purpose, an applicator 11 is provided in the illustrated embodiment that applies the adhesive in question, for example in the form of a hot melt, by spraying it onto one side of the textile support tape T. Of course, this is only by way of example. The support tape T thus coated can then be cut longitudinally and wound to form adhesive tape rolls 12.

As the only FIGURE shows, individual phases of the production of the hand-tearable textile adhesive tape according to the invention can be carried out separately from each other, both in terms of location and time. It is possible, for example, to initially weave the textile support tape T. This textile support tape T is then made available at the supply 1 for further processing. In a supplemental second production step, the described alkalinization process is carried out with subsequent washing, neutralizing and drying, at the end of which the hand-tearable textile support tape T is ready on the winder 10. In a further third step, this hand-tearable textile support tape T can then be coated on at least one side with the adhesive, as shown schematically in the upper portion of the FIGURE. At the end of this process, the individual adhesive tape rolls 12 are available. It goes without saying that all processes can also be implemented in one continuous line.

The textile support tape that is used, as already described above, is a polyester woven textile support tape. This may be dyed black. The permeability of this tape to air is typically less than 500 mPa/sec (EN ISO 9237:1995; 2.0 mbar). The longitudinal stretch to break is approximately 25 plus/min 5% (DIN EN 14410:2003). The thickness of the adhesive tape produced by this support tape T is in the range of approximately 0.1 mm. The basis weight is approximately 70 g/m².

The woven fabric is composed of approximately 31 warp filaments/cm and approximately 27 weft filaments/cm. Fineness is more than 2500 dtex/cm for the warp filaments. A comparable number applies to the weft filaments.

Finally, it should also be emphasized that the treatment with the processing liquid 4 in the treatment device 3 is controlled in such a way that the textile support tape T essentially has a tensile strength of less than 100 N/cm at the output of the treatment device 3. To achieve this in detail, the procedure employed within the scope of the invention is substantially empirically adjusting the treatment time within the treatment device 3, the concentration of the processing liquid or sodium hydroxide 4, the temperature thereof and the speed of passage in the travel direction A, under consideration of the above-described parameters, and by measuring the corresponding tensile strength values.

However, essentially it is also possible, for example, to vary the speed of the textile support tape T in the travel direction A to achieve the desired control. In this case, the tensile strength of the textile support tape T is measured in the starting condition at the input of the treatment device 3, and the tensile strength of the textile support tape T is also measured after passing through the treatment device 3. Depending on whether the tensile strength is less than 100 N/cm at the output of the treatment device 3, the throughput speed of the textile support tape T in the travel direction A can then be raised, and thus productivity can be increased.

In contrast, if the tensile strength of the textile support tape T at the output of the treatment device 3 is above 100 N/cm, this measurement calls for decreasing the throughput speed of the textile support tape T in the travel direction A. As a result, the processing or residence time in the treatment device 3 increases, and it is to be expected that the tensile strength is thereby decreased, with otherwise identical parameters.

In this context, the throughput speed can be successively reduced until the tensile strength has the desired value of less than 100 N/cm at the output of the treatment device 3. A comparable process can also be employed when it comes to setting the percentage decrease in the tensile strength of at least 5% at the output of the treatment device 3 compared to the starting condition on the supply for the desired control.

1. A method of making a hand-tearable textile adhesive tape comprising the following method steps:
treating a textile support tape with a processing liquid capable of weakening fibers until a tensile strength of the tape is less than 100 N/cm;
subsequently washing and neutralizing the textile support tape; and
finally applying a coating containing an adhesive to at least one side of the support tape.

2. The method according to claim 1, wherein the textile support tape is treated with the processing liquid in a continuous or a discontinuous process.

3. The method according to claim 2, wherein the textile support tape is guided continuously through a treatment device at a predefined speed and in at least one pass.

4. The method according to any one of claim 1, further comprising the step of:
using the textile support tape a lye or an acid as the processing liquid.

5. The method according to claim 1, further comprising the step of:
heating the processing liquid to a temperature of least 50° C.

6. The method according to claim 1, further comprising the step of:
using a woven textile support tape made of polymer filaments as the textile support tape.

7. The method according to claim 6, wherein the textile support tape is a polyester woven textile support tape.

8. The method according to claim 7, further comprising the step of:
alkalinizing the polyester woven textile support tape.

9. The method according to claim 8, wherein the polyester woven textile support tape is alkalinized using sodium hydroxide.

10. The method according to claim 9, wherein the sodium hydroxide has a concentration of at least 10 g/l.

11. The method according to claim 1, wherein the textile support tape is treated with the processing liquid for a treatment time of at least 4 minutes.

12. The method according to wherein the textile support tape is treated in the treatment device using a liquor ratio of 1:20 and more.

13. A system for making a hand-tearable textile adhesive tape, the system comprising:
a supply for textile support tape;
a treatment device in which the textile support tape from the supply is treated with a processing liquid capable of weakening fibers until a tensile strength of the tape is less than 100 N/cm;
a washer for washing and neutralizing the textile support tape after the treatment; and
a final applicator for coating at least one side of the support tape with an adhesive.

14. The system according to claim 13, wherein the treatment device is designed as an alkalinization unit.

15. The system according to claim 13, further comprising:
a cleaning station for removing oils or grease from the textile support tape upstream of the treatment device.
